(19) United States
(12) Patent Application Publication
(10) Pub. No.: US 2026/0111389 A1
(43) Pub. Date: Apr. 23, 2026

(54) JUMPER CONFIGURATION FINGERPRINTING FOR HARDWARE CONFIGURATION MONITORING IN COMPUTING SYSTEMS

(71) Applicant: Aivres Systems Inc., Fremont, CA (US)

(72) Inventor: Zuo Syuan WANG, New Taipei City (TW)

(21) Appl. No.: 19/423,923

(22) Filed: Dec. 17, 2025

(51) Int. Cl. G06F 13/42

(52) U.S. Cl. CPC G06F 13/4282; G06F 2213/0016

(57) ABSTRACT

Methods and systems are disclosed for monitoring jumper configurations on a circuit board. A programmable logic device (PLD) receives logic signals from a plurality of jumper blocks via pins and generates a fingerprint value encoding current jumper states. A management controller, such as a baseboard management controller (BMC), obtains the fingerprint from the PLD and detects whether the fingerprint differs from a stored fingerprint encoding previous jumper states. When a difference is detected, the management controller reads the current jumper states from the PLD over a communication interface and may compare the current jumper states with a golden configuration table defining valid jumper configurations. The fingerprint is sized to fit within a single transfer unit of the communication interface, reducing bus usage relative to repeatedly transferring all jumper states.

### TECHNICAL FIELD

The present disclosure relates generally to hardware configuration monitoring in computing systems, and more particularly to systems and methods for monitoring and validating jumper configurations on circuit boards using a programmable logic device and a management controller.

### BACKGROUND

Server and other computing system motherboards commonly employ jumper blocks to set hardware parameters, such as power regulation options, boot sources, debug modes, and factory test configurations. Different engineering and operations teams, including validation, manufacturing, and field support, often rely on different jumper combinations to exercise specific subsystems. As the number of jumpers and supported modes increases, the configuration space becomes more complex and more difficult to verify reliably.

In many existing platforms, jumper settings are still checked manually. A technician visually inspects the board and compares observed jumper positions against a paper drawing or static documentation. This process is time-consuming, depends heavily on human attention, and is prone to mistakes. A single misplaced jumper can prevent a system from booting, place voltage rails in an unintended state, or expose debug or factory-only features in a shipping configuration. When different teams use different intended profiles, such as normal, factory, and debug configurations, the risk of misconfiguration further increases.

Even where management controllers are present on the platform, jumper configuration is often treated as a static, board-level concern and is not integrated into automated validation or security mechanisms. Conventional solutions typically lack a compact, machine-friendly representation of the overall jumper configuration that can be checked frequently without consuming significant bandwidth on management interfaces. They also do not provide systematic comparison of a current jumper configuration against predefined “golden” profiles for different operating modes, nor do they readily support using the jumper configuration as a hardware-level signature during secure boot.

As a result, existing systems make it difficult to efficiently and reliably detect incorrect or unsafe jumper settings across all relevant subsystems, to enforce mode-specific configuration rules during manufacturing, deployment, and service, and to integrate jumper configuration checks into remote management and platform security mechanisms.

### SUMMARY

A system of one or more computers can be configured to perform particular operations or actions by virtue of having software, firmware, hardware, or any combination of them installed on the system that, in operation, causes the system to perform the actions. One or more computer programs can be configured to perform particular operations or actions by including instructions that, when executed by data processing apparatus, cause the apparatus to perform the actions.

In one general aspect, a computer-implemented method includes, at a programmable logic device disposed on a circuit board, receiving, via a plurality of input pins of the programmable logic device, respective logic signals corresponding to a plurality of jumper blocks disposed on the circuit board, and generating, based on the received logic signals, a fingerprint value encoding current states of the plurality of jumper blocks. The computer-implemented method also includes, at a management controller communicatively coupled to the programmable logic device, obtaining, from the programmable logic device, the fingerprint value, determining whether the plurality of jumper blocks have changed states based on the fingerprint value and a stored fingerprint value encoding previous states of the plurality of jumper blocks, and, responsive to determining that the plurality of jumper blocks have changed states, obtaining, via a communication interface, the current states of the plurality of jumper blocks. Other embodiments of this aspect include corresponding computer systems, apparatus, and computer programs recorded on one or more computer-storage devices, each configured to perform the actions of the methods.

Implementations of the method can include one or more of the following features. The programmable logic device may comprise a complex programmable logic device (CPLD), and the management controller may comprise a baseboard management controller (BMC). Each of the plurality of jumper blocks may include a plurality of pins, and only one pin of each jumper block is electrically coupled to a respective one of the plurality of input pins of the programmable logic device. Generating the fingerprint value may include obtaining, in a same clock cycle of the programmable logic device, logic signals present at the plurality of input pins and encoding the logic signals as a bit vector representing the current states of the plurality of jumper blocks, where the fingerprint value is generated based on the bit vector. Generating the fingerprint value may further include applying a checksum function, a hash function, or a cyclic redundancy check function to a bit vector representing the current states of the plurality of jumper blocks. The communication interface may include at least one of an I²C (Inter-Integrated Circuit) interface or an SGPIO (Serial General-Purpose Input/Output) interface. The communication interface may be configured to transfer, in a single transfer unit or clock interval, a first amount of data between the programmable logic device and the management controller, and the fingerprint value may have a data size that is not greater than the first amount of data such that the fingerprint value is transferable over the communication interface in the single transfer unit or clock interval. The management controller may be configured to update the stored fingerprint value to the obtained fingerprint value after obtaining the current states of the plurality of jumper blocks. After determining that the plurality of jumper blocks have changed states and obtaining the current states of the plurality of jumper blocks via the communication interface, the method may include computing, at the management controller, a recomputed fingerprint value based on the current states of the plurality of jumper blocks and determining that a transmission error has occurred when the recomputed fingerprint value differs from the obtained fingerprint value. The method may include determining, at the management controller, whether the plurality of jumper blocks are in a valid configuration based on the current states of the plurality of jumper blocks and a golden configuration table that defines one or more valid jumper configurations for the plurality of jumper blocks, where the golden configuration table includes a plurality of mode-specific profiles having at least a normal-mode profile and a factory-mode profile. Responsive to determining that the plurality of jumper blocks are not in the valid configuration, the method may include recording an event in a system event log maintained by the management controller and causing a graphical user interface associated with the management controller to display an indication of an invalid jumper configuration. Responsive to determining that the plurality of jumper blocks are in an unsafe configuration having a mutually exclusive or hazardous combination of jumper states, the method may include inhibiting a boot sequence of the circuit board. The programmable logic device may be configured to generate the fingerprint value and to assert an interrupt signal toward the management controller, and the obtaining of the fingerprint value from the programmable logic device may be performed by the management controller in response to receipt of the interrupt signal. In another implementation, the programmable logic device is configured to generate the fingerprint value, and the obtaining of the fingerprint value from the programmable logic device is performed by the management controller periodically polling the programmable logic device via the communication interface. The method may further include, at the programmable logic device, generating the fingerprint value within a startup interval following application of power to the circuit board and before execution of main system firmware on the circuit board, and, during a secure boot sequence initiated by at least one of the management controller and a basic input/output system (BIOS), comparing the fingerprint value with a reference fingerprint value stored as a factory record and, responsive to a mismatch between the fingerprint value generated within the startup interval and the reference fingerprint value, preventing completion of a boot of the computing system or causing the computing system to enter a mode that restricts operation of the computing system. In some implementations, the circuit board is one of a plurality of circuit boards of a computing system, each of the plurality of circuit boards includes a respective programmable logic device that generates a respective fingerprint value encoding current states of jumper blocks on the respective circuit board, and the method further includes obtaining the respective fingerprint values from the plurality of circuit boards and generating, at the management controller, a machine identifier based on the respective fingerprint values. Implementations of the described techniques may be realized in hardware, in a method or process, or in a computer-readable medium.

In another general aspect, a computing system includes a circuit board and a plurality of jumper blocks disposed on the circuit board configured to set respective hardware parameters of a plurality of subsystems of the computing system. The system further includes a programmable logic device disposed on the circuit board and having a plurality of input pins, and a plurality of electrical connections respectively coupling each of the plurality of jumper blocks to a corresponding one of the plurality of input pins of the programmable logic device such that logic signals at the plurality of jumper blocks are sensed by the programmable logic device. The system also includes a management controller communicatively coupled to the programmable logic device via a communication interface. The programmable logic device is configured to generate a fingerprint value encoding the sensed logic signals at the plurality of jumper blocks and to provide the fingerprint value to the management controller via the communication interface. The management controller is configured to obtain the fingerprint value from the programmable logic device via the communication interface and to determine whether the plurality of jumper blocks have changed states based on the fingerprint value and a stored fingerprint value encoding previous states of the plurality of jumper blocks. Other embodiments of this aspect include corresponding computer systems, apparatus, and computer programs recorded on one or more computer-storage devices, each configured to perform the actions of the methods.

Implementations of the computing system can include one or more of the following features. The plurality of subsystems may include power regulation circuitry related to the programmable logic device and at least one of a central processing unit (CPU), a basic input/output system (BIOS), a graphics processing unit (GPU), and a peripheral component interconnect express (PCIe) subsystem. The management controller may be further configured to determine whether the plurality of jumper blocks are in a valid configuration based on the current states of the plurality of jumper blocks and a golden configuration table that defines one or more valid jumper configurations for the plurality of jumper blocks, where the golden configuration table includes a plurality of mode-specific profiles having at least a normal-mode profile and a factory-mode profile. Implementations of the described techniques may be realized in hardware, in a method or process, or in a computer-readable medium.

In another general aspect, a non-transitory computer-readable medium storing instructions is provided. The instructions, when executed by a management controller of a computing system, cause the management controller to obtain, from a programmable logic device disposed on a circuit board of the computing system, a fingerprint value encoding current states of a plurality of jumper blocks disposed on the circuit board, where the programmable logic device has generated the fingerprint value based on logic signals received via a plurality of input pins of the programmable logic device that are respectively coupled to the plurality of jumper blocks. The instructions further cause the management controller to determine whether the plurality of jumper blocks have changed states based on the fingerprint value and a stored fingerprint value encoding previous states of the plurality of jumper blocks and, responsive to determining that the plurality of jumper blocks have changed states, to obtain, via a communication interface, the current states of the plurality of jumper blocks. Other embodiments of this aspect include corresponding computer systems, apparatus, and computer programs recorded on one or more computer-storage devices, each configured to perform the actions of the methods.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates some example jumper blocks that are widely used in computing systems.

FIG. 2 illustrates an example system diagram of jumper configuration fingerprinting for hardware configuration monitoring in computing systems, according to some embodiments.

FIG. 3 illustrates a workflow of jumper configuration fingerprinting for hardware configuration monitoring in computing systems, according to some embodiments.

FIG. 4 illustrates an example golden configuration table maintained by a board management controller (BMC) for monitoring and managing jumper configuration, according to some embodiments.

FIG. 5 illustrates an example method of jumper configuration fingerprinting for hardware configuration monitoring in computing systems.

FIG. 6 illustrates a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

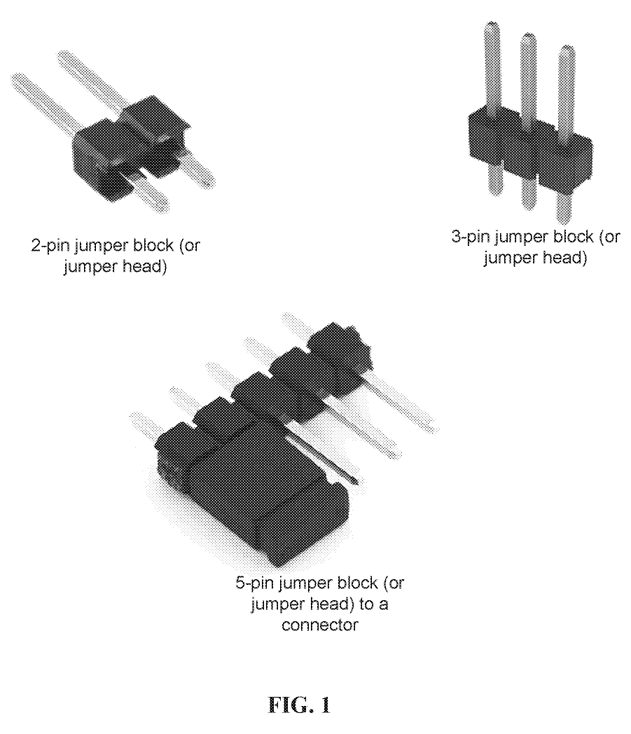

FIG. 1 illustrates several example jumper blocks, also referred to as jumper heads, of the type that are commonly used on server and other electronic system motherboards. As shown, jumper blocks may have different pin counts, such as a two-pin jumper block, a three-pin jumper block, or a five-pin jumper block, in which the adjacent pins may be adapted to mate with a connector. In typical use, a removable shunt bridges two adjacent pins of a jumper block to select between different hardware configurations. For example, on a three-pin jumper block, a shunt connecting a first pair of pins may represent a logic “0” state, while a shunt connecting a second pair of pins may represent a logic “1” state. Modern server boards can carry dozens of such jumper blocks distributed across the board, controlling a wide variety of power, reset, boot, debug, and test behaviors.

In a server manufacturing and validation environment, jumper blocks are used to configure multiple operating modes. During board bring-up and voltage regulator (VR) debug, certain jumpers may force power rails on or enable special measurement points. In a factory test mode, other jumpers may enable fan tests, alternate UART ports, or special firmware programming paths for complex programmable logic devices (CPLDs) and other components. For shipping, the same hardware is typically placed into a normal mode in which debug-only features are disabled, security jumpers are locked, and production boot sources are selected. Different teams therefore rely on different combinations of jumper settings to exercise subsystems such as power regulation circuitry, central processing units (CPUs), basic input output system (BIOS) devices, graphics processing units (GPUs), and peripheral component interconnect express (PCIe) subsystems. A single misplaced jumper can prevent a board from booting, damage sensitive components, or leave a product in an insecure or factory-only configuration when delivered to a customer.

As mentioned in the background section, despite the critical role of jumper blocks, many existing platforms still rely on manual verification. A technician visually inspects the board, locates each jumper block, and compares the observed shunt positions against a printed checklist or a schematic drawing. This approach is slow, error-prone, and difficult to scale as the number of jumpers and supported modes grows. It is particularly fragile in high-volume manufacturing or field-service scenarios, where boards may pass through multiple hands and where configuration drift can be introduced by hurried rework or ad-hoc debugging. Moreover, manual inspection offers no straightforward way to integrate jumper configuration into automated test scripts, remote management tools, or secure boot policies.

On the other hand, to support more automation, server boards often include a management controller, such as a baseboard management controller (BMC), and one or more programmable logic devices (PLDs). A PLD, which may be implemented as a complex PLD (CPLD) or another type of programmable logic device, typically has a relatively large number of general-purpose input/output (GPIO) pins (also called pins, I/O pins, or input pins, interchangeably) and is well suited to sampling digital signals on the board. The BMC, in contrast, is a more complex processor that manages power sequencing, sensor monitoring, firmware updates, and out-of-band management traffic over communication interfaces. The BMC communicates with PLDs, power controllers, and other devices using management interfaces such as I²C or SGPIO. The design disclosed subsequently utilizes this architecture and allows jumper states to be digitized by the PLD and reported to the BMC, which can then perform management tasks, and present the configuration in a graphical user interface or log it for traceability.

However, a brute-force solution in which all jumper blocks on the board are read out in full by the PLD and the complete jumper state is then transmitted to the BMC (whether continuously, periodically, or in an interrupt-driven manner) is not practical at scale. When dozens of jumper blocks are present, the PLD must expose an array of jumper-state registers, and the BMC must read that entire register over a relatively low-bandwidth management bus. Because such buses typically transfer only one or a few bytes per clock cycle, obtaining the complete state of, for example, thirty-two jumper blocks may require multiple clock intervals or transfer units (for instance, eight cycles to read eight bytes). Frequent full-width reads increase polling latency and consume a significant portion of the available management-bus bandwidth. This is undesirable because the BMC is already responsible for communicating with many other components in the system, including power controllers, temperature sensors, nonvolatile memory devices, and remote management endpoints. Accordingly, a naïve approach that simply connects all jumper blocks to the PLD and requires the BMC to retrieve all jumper states on every check results in inefficient use of the management interface and does not scale well as the number of jumper blocks increases.

Subsequent figures and description focus on embodiments in which a PLD aggregates signals from a plurality of jumper blocks, computes a compact fingerprint that encodes the overall jumper configuration, and cooperates with the BMC to enable efficient, automated verification of jumper states across different operating modes without requiring the BMC to repeatedly read all jumper signals individually.

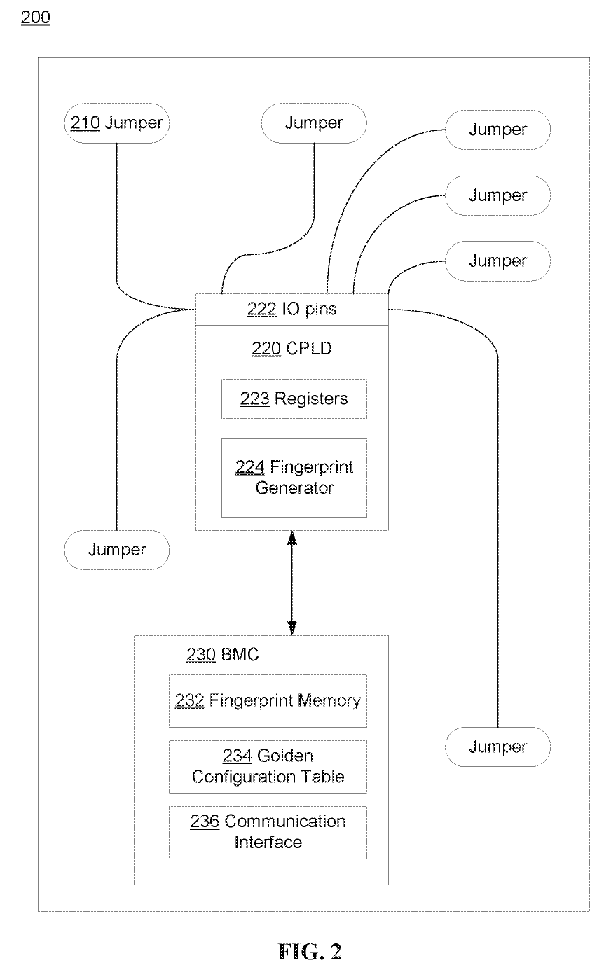

FIG. 2 illustrates an example system diagram of jumper configuration fingerprinting for hardware configuration monitoring in computing systems, according to some embodiments.

In the illustrated embodiment, a circuit board 200 includes a plurality of jumper blocks, including a jumper block 210 and other jumper blocks collectively labeled “Jumper” in FIG. 2. Each of these jumper blocks 210 is configured to set one or more hardware parameters of the circuit board 200, such as power behavior, boot source selection, security settings, or enablement of particular devices. A programmable logic device, which in some embodiments is implemented as a complex programmable logic device (CPLD) 220, is disposed on the circuit board 200 and comprises a plurality of input pins 222 (also called IO pins). As shown, a plurality of electrical connections are routed on the circuit board 200 between the jumper blocks 210 and the input pins 222 of the CPLD 220 such that logic signals at the jumper blocks 210 are sensed by the CPLD 220. Many existing circuit boards do not include direct connections from all jumper blocks 210 to the CPLD 220. To implement the embodiments described herein, additional hardware wiring may be added so that jumper blocks 210 that previously were not monitored by the CPLD 220, such as jumper blocks associated with CPUs, security functions, flash devices, accelerators, or other chips, are connected to corresponding ones of the input pins 222. In some existing designs, certain power-related jumper blocks may already be wired to the CPLD 220, and these connections can be reused.

In some embodiments, each jumper block 210 generates a single logical signal that is sufficient to represent its current state. For example, on a three-pin jumper block, only the middle pin may need to be sensed to determine whether the jumper is in an “enabled” or “disabled” position. In such embodiments, only that signal-generating pin of each jumper block is connected to a respective one of the input pins 222 of the CPLD 220. The CPLD 220 samples the logic signals present at the input pins 222 and stores corresponding digital values in an array of registers 223. The registers 223 thus store the current states of the plurality of jumper blocks. In some embodiments, the signals may be represented as a bit vector or array of bits representing the board-wide jumper configuration at a particular point in time.

In some embodiments, the CPLD 220 further includes a fingerprint generator 224. The fingerprint generator 224 generates a fingerprint value based on the contents of the registers 223 (i.e., the signal levels of the board-wide jumper blocks 210). In different embodiments, the fingerprint generator 224 may implement a checksum function, a hash function, a cyclic redundancy check (CRC) function, or another function that maps the bit vector stored in the registers 223 to a compact fingerprint value. The fingerprint value encodes the current states of the plurality of jumper blocks in a compressed form suitable for efficient transmission (e.g., 1 byte for single-cycle transmission). The CPLD 220 is configured to provide the fingerprint value to a management controller 230 over a communication interface, which in some embodiments may be implemented using an I²C interface, an SGPIO interface, or another management bus, and which corresponds to the communication interface 236 described below.

In addition to the CPLD 220, the board 200 may also include a management controller 230 that may be implemented as a baseboard management controller (BMC) 230. In some embodiments, the BMC 230 includes a fingerprint memory 232, a golden configuration table 234 e.g., stored in a memory or storage media), and a communication interface 236. The fingerprint memory 232 may be configured to store one or more fingerprint values. In some embodiments, the fingerprint memory 232 stores a previously received (from the CPLD 220) or previously computed fingerprint value encoding previous states of the plurality of jumper blocks 210, for example a fingerprint value obtained during a prior sampling interval, during a previous boot sequence, or during factory configuration.

When the CPLD 220 generates a new fingerprint value, the CPLD 220 provides the fingerprint value to the BMC 230 via the communication interface 236. Because the fingerprint value is a compact representation of the states of all monitored jumper blocks, only a small amount of data needs to be transferred over the communication interface 236, rather than the full set of bits representing every jumper state. In some embodiments, the fingerprint value is sized so that it fits within a single transfer unit or clock interval on the communication interface 236, whereas reading out all jumper states would require multiple transfer units or clock intervals. Upon receiving the new fingerprint value, the BMC 230 accesses the fingerprint memory 232 and detects whether the new fingerprint value differs from the stored fingerprint value. If the new fingerprint value is identical to the stored fingerprint value, the BMC 230 can determine that the plurality of jumper blocks have not changed states since the previous sampling and may skip reading the individual jumper states. If the new fingerprint value differs from the stored fingerprint value, the BMC 230 determines that the plurality of jumper blocks may have changed states and initiates further processing.

In some embodiments, to avoid false positive indications caused by hash collision or transmission errors on the communication interface 236, the BMC 230, after detecting that the new fingerprint value differs from the stored fingerprint value, reads the contents of the registers 223 from the CPLD 220 via the communication interface 236 to obtain the current states of the plurality of jumper blocks 210. The BMC 230 then recomputes, based on the current states, a recomputed fingerprint value and compares the recomputed fingerprint value with the new fingerprint value received from the CPLD 220. If the recomputed fingerprint value does not match the new fingerprint value, the BMC 230 may determine that a transmission error has occurred and may log an error or retry the read. If the recomputed fingerprint value matches the new fingerprint value but mismatches the stored fingerprint value, the BMC 230 may confirm that the plurality of jumper blocks have actually changed states and may proceed to verify whether the new jumper configuration is valid by comparing the current states of the plurality of jumper blocks with one or more profiles stored in the golden configuration table 234.

The golden configuration table 234 on the BMC 230 may be used to verify the configuration of the jumper blocks. In some embodiments, the golden configuration table 234 may store configuration reference data that defines one or more valid jumper configurations for the plurality of jumper blocks 210. In some embodiments, the golden configuration table 234 comprises multiple mode specific profiles, such as a normal mode profile, a factory mode profile, and a debug mode profile, each profile specifying expected states for the jumper blocks 210 in a respective operating mode of the circuit board 200.

The communication interface 236 of the BMC 230 provides the hardware link between the BMC 230 and the CPLD 220 and is used both to obtain the fingerprint value and, when needed, to obtain the current states of the plurality of jumper blocks by reading the contents of the registers 223. For example, when the BMC 230 detects that a newly received fingerprint value differs from the stored fingerprint value in the fingerprint memory 232, the BMC 230 may, via the communication interface 236, read out the registers 223 from the CPLD 220 to obtain the current states of the plurality of jumper blocks. The BMC 230 can then compare the current states with a selected profile in the golden configuration table 234 to determine whether the plurality of jumper blocks are in a valid configuration, log any invalid configuration, or perform additional actions as described in further embodiments below.

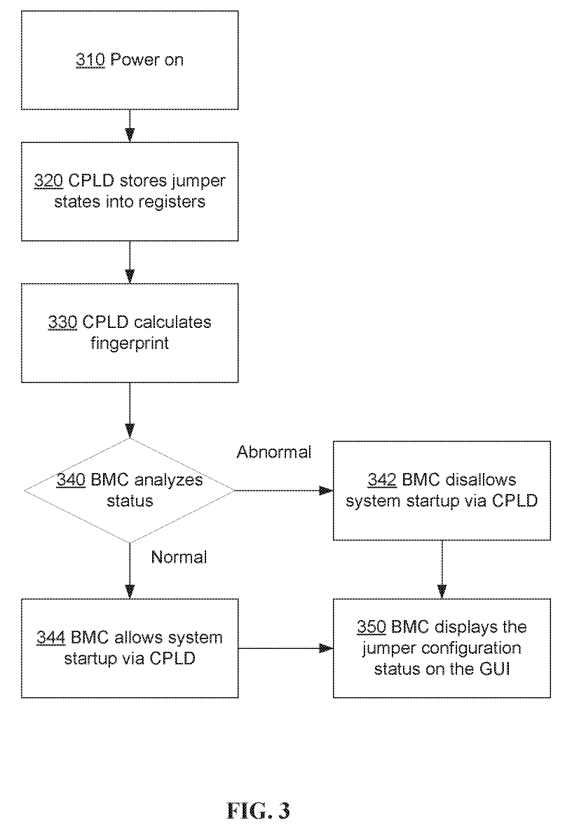

FIG. 3 illustrates a workflow of jumper configuration fingerprinting for hardware configuration monitoring in computing systems, according to some embodiments.

At step 310, power is applied to the circuit board and a startup interval begins. During this interval, before execution of main system firmware on the circuit board, the programmable logic device (for example, a CPLD) detects the logic signals received from the plurality of jumper blocks via the input pins 222 and, at step 320, stores corresponding digital values into the registers (223 in FIG. 2). The registers 223 may store the current states of the plurality of jumper blocks, which may be encoded by the CPLD as a bit vector representing a board-wide jumper configuration.

At step 330, a fingerprint generating logic within the CPLD may generate a fingerprint value based on the bit vector stored in the registers. In different embodiments, the fingerprint generating logic may implement a checksum, hash function, or cyclic redundancy check function that maps the bit vector to a compact fingerprint value sized to fit within a single transfer unit or clock interval of the communication interface between the CPLD and the BMC.

At step 340, the BMC may analyze the jumper configuration status based on the fingerprint value. In some embodiments, the CPLD is configured to generate the fingerprint value at power-on and to assert an interrupt signal toward the BMC when the fingerprint value is ready. The obtaining, from the CPLD, of the fingerprint value at step 340 is then performed by the BMC in response to receipt of the interrupt signal. In other embodiments, the CPLD periodically updates the fingerprint value or updates the fingerprint value when any of the jumper blocks changes its signal level, and the BMC obtains the fingerprint value at step 340 by periodically polling the CPLD via the communication interface. In either case, the fingerprint value is transferred from the CPLD to the BMC over the communication interface without transferring the full contents of the registers. Subsequently, the BMC accesses the fingerprint memory to retrieve a stored fingerprint value encoding previous states of the plurality of jumper blocks and detects whether the new fingerprint value differs from the stored fingerprint value. If the new fingerprint value is identical to the stored fingerprint value, the BMC determines that the plurality of jumper blocks have not changed states and may allow system startup to proceed via the CPLD, for example by asserting a startup-allow signal that permits the CPLD to continue its power-on for the computing system (step 344, the normal branch). If the new fingerprint value differs from the stored fingerprint value, the BMC determines that the plurality of jumper blocks have changed states and proceeds to obtain the current states of the plurality of jumper blocks from the registers 223 via the communication interface 236.

In some embodiments, when a difference between fingerprint values is detected at step 340, the BMC first performs a transmission-error check. The BMC reads the contents of the registers from the CPLD via the communication interface, recomputes a fingerprint value based on the current states of the plurality of jumper blocks, and compares the recomputed fingerprint value with the fingerprint value received from the CPLD. If the recomputed fingerprint value does not match the received fingerprint value, the BMC determines that a transmission error has occurred, may log an error, and may prevent the system startup via the CPLD (step 342, the abnormal branch, e.g., by withholding or deasserting the startup-allow signal so that the CPLD does not enable power rails or release system reset). If the recomputed fingerprint value matches the received fingerprint value, the BMC confirms that the jumper configuration has actually changed and may update the stored fingerprint value in the fingerprint memory with the new fingerprint value.

Once the current states of the plurality of jumper blocks have been obtained and, optionally, verified for transmission errors, the BMC evaluates whether the jumper configuration is valid. In some embodiments, during a secure boot sequence initiated by at least one of the BMC and a basic input output system (BIOS), the fingerprint value generated within the startup interval is further compared with a reference fingerprint value stored as a factory record, called a golden configuration table. If the fingerprint value does not match the reference fingerprint value, the BMC determines that the board is not in an approved configuration for the current mode and, at step 342, disallows system startup via the CPLD, for example by inhibiting release of reset signals or by preventing power sequencing of critical rails. That is, the detected unsafe or unexpected combination of jumper states results in the boot sequence being inhibited or the computing system being placed into a mode that restricts operation. If the fingerprint value indicates a configuration that is acceptable for the current mode and matches an entry in the golden configuration table 234, the BMC categorizes the configuration as normal and, at step 344, allows the CPLD to continue with system startup.

In some embodiments, regardless of whether the configuration is deemed normal or abnormal, the BMC records the result in a system event log and exposes the jumper configuration to a graphical user interface. As illustrated at step 350, the BMC may display the jumper configuration status on a GUI, including, for example, indications of whether the configuration conforms to a selected mode specific profile in the golden configuration table, or whether particular jumper blocks contribute to an invalid or unsafe configuration. This allows manufacturing, validation, or field-service personnel to visually or even remotely view the jumper configuration without removing covers or physically accessing the circuit board.

In multi-board computing systems, such as a chassis containing multiple server nodes or a modular system with several plug-in cards, each circuit board may include its own programmable logic device (CPLD) configured to monitor local jumper blocks and to generate a respective fingerprint value encoding current states of those jumper blocks. A sequence similar to that shown in FIG. 3 may be executed independently on each circuit board, with the BMC (one BMC managing multiple CPLDs) obtaining the respective fingerprint values from the multiple CPLDs via one or more communication interfaces. In some embodiments, the BMC aggregates the respective fingerprint values into a machine identifier that uniquely characterizes the overall hardware configuration of the computing system. For example, the machine identifier may be formed by concatenating the fingerprint values in a defined order, by hashing the set of fingerprint values, or by combining them with additional platform identifiers. The machine identifier can then be used for purposes such as configuration tracking, enforcement of firmware compatibility, automatic selection of appropriate golden configuration profiles, or inventory and audit of system level hardware states across a data center.

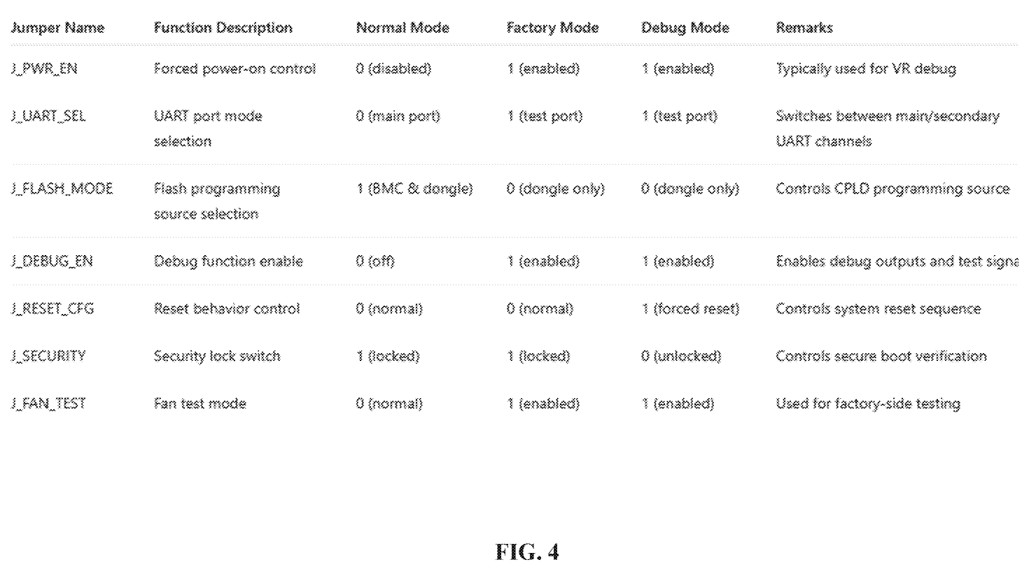

FIG. 4 illustrates an example golden configuration table maintained by the BMC for monitoring and managing jumper configuration, according to some embodiments. The table includes an entry for each jumper block on the circuit board, identified by a jumper name such as J_PWR_EN (power enable), J_UART_SEL (Universal Asynchronous Receiver/Transmitter port selection), J_FLASH_MODE (flash programming source), J_DEBUG_EN (debug enable), J_RESET_CFG (reset configuration), J_SECURITY (security lock), and J_FAN_TEST (fan test mode). For each jumper name, the golden configuration table shows a function description, desired jumper states for different operating modes (for example, a normal mode, a factory mode, and a debug mode), and optional remarks describing the intended usage. For instance, J_PWR_EN may control forced power-on and is expected to be disabled in a normal mode but enabled in factory and debug modes, whereas J_SECURITY may control a security lock switch and is expected to be locked in normal and factory modes but unlocked in a debug mode. The tabular representation of FIG. 4 is provided primarily for explanatory purposes and may be stored in the BMC in a human-readable format so that an operator can review, verify, or update mode specific profiles. These examples illustrate that each profile encodes a particular combination of jumper states corresponding to a valid configuration for a given stage of manufacturing, testing, or deployment.

In some embodiments, the golden configuration table is generated during hardware design and manual construction by the platform designer. For runtime use, the human-readable entries of the golden configuration table are converted into a plurality of machine-usable bit vectors, each bit vector representing one valid jumper configuration for a particular profile. These bit vectors may be stored in association with, or derived from, the table of FIG. 4, which remains available for operator inspection and modification, while the bit vectors are used by the BMC for real-time comparison.

During operation, after the BMC obtains the current states of the plurality of jumper blocks from the programmable logic device via the communication interface, the BMC aggregates the jumper signal levels into an observed bit vector using the same bit-position mapping. The observed bit vector is then compared with the one or more golden bit vectors associated with the selected profile in the golden configuration table. If the observed bit vector matches at least one golden bit vector, the configuration is deemed valid for that mode. If no match is found, the configuration is considered invalid, and the BMC may record an event in a system event log, inhibit system startup, or display an indication of the invalid jumper configuration on a graphical user interface. In some embodiments, the golden configuration table may also support “reserved” bits (e.g., “don’t care” bits), allowing certain jumpers to be ignored for a given profile, or may be updated in the field to accommodate new hardware revisions or SKU-specific jumper options, while the comparison logic remains based on matching the observed bit vector against one or more stored golden vectors.

### Other embodiments

The elements shown in FIG. 2 can be incorporated into a computing system in which the circuit board 200 forms part of a server, storage node, or other electronic platform. In such a computing system, the plurality of jumper blocks disposed on the circuit board 200 are configured to set respective hardware parameters of a plurality of subsystems of the computing system, including power regulation circuitry related to the programmable logic device 220 and, in various embodiments, one or more of a central processing unit (CPU), a basic input output system (BIOS), a graphics processing unit (GPU), and a peripheral component interconnect express (PCIe) subsystem. The programmable logic device 220, its input pins 222, the electrical connections from the jumper blocks, and the management controller 230 with the communication interface 236 thus collectively implement the computing system features recited in the system claims.

In some embodiments, the behavior of the management controller 230 described above is implemented by execution of software or firmware instructions on one or more processors of the management controller 230. These instructions may be stored in a non-transitory computer-readable medium such as flash memory, electrically erasable programmable read-only memory (EEPROM), or other persistent storage associated with the management controller 230. When executed, the instructions cause the management controller 230 to obtain, from the programmable logic device 220 via the communication interface 236, a fingerprint value encoding current states of the plurality of jumper blocks; to detect, using a stored fingerprint value encoding previous states of the plurality of jumper blocks, whether the plurality of jumper blocks have changed states; and, responsive to determining that the plurality of jumper blocks have changed states, to obtain, via the communication interface 236, the current states of the plurality of jumper blocks from the programmable logic device 220. Additional instructions may cause the management controller 230 to recompute a fingerprint value based on the obtained current states, to compare the recomputed fingerprint value with the fingerprint value received from the programmable logic device 220, to determine whether a transmission error has occurred, and to determine whether the plurality of jumper blocks are in a valid configuration based on the golden configuration table 234.

The same non-transitory computer-readable medium may also store instructions that, when executed by the management controller 230, cause the management controller 230 to update the stored fingerprint value in the fingerprint memory 232 after confirming a change in the jumper configuration, to generate or update a machine identifier based on respective fingerprint values obtained from multiple circuit boards in a multi-board computing system, and to record events or display indications of invalid or unsafe jumper configurations through a graphical user interface. These software and firmware implementations correspond to the computer-implemented operations recited in the method claims and support the computer-readable medium claim directed to the management controller of the computing system.

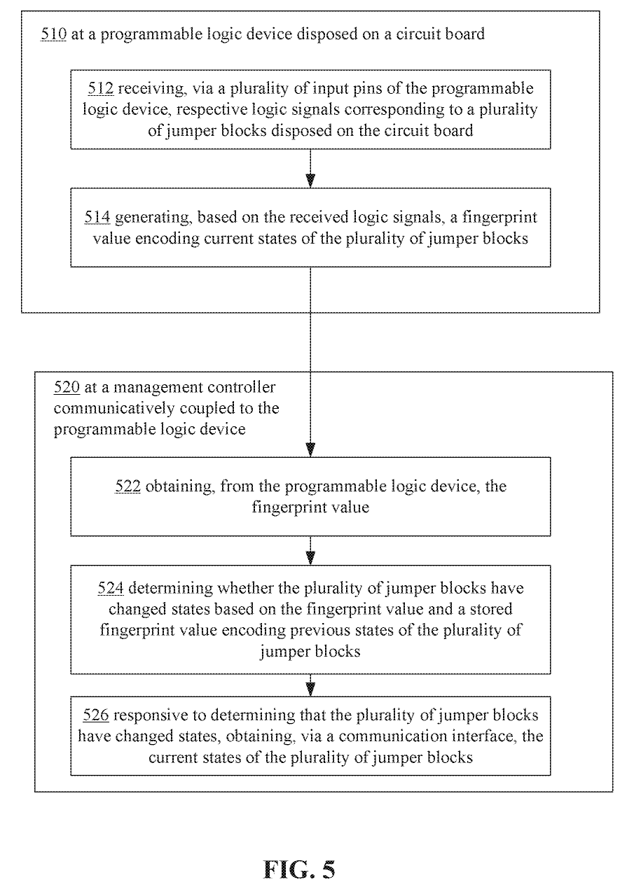

FIG. 5 illustrates an example method of jumper configuration fingerprinting for hardware configuration monitoring in computing systems. At step 510, operations are performed at a programmable logic device disposed on a circuit board. At step 512, the programmable logic device receives, via a plurality of input pins of the programmable logic device, respective logic signals corresponding to a plurality of jumper blocks disposed on the circuit board. At step 514, the programmable logic device generates, based on the received logic signals, a fingerprint value encoding current states of the plurality of jumper blocks. At step 520, operations are performed at a management controller communicatively coupled to the programmable logic device. At step 522, the management controller obtains, from the programmable logic device, the fingerprint value. At step 524, the management controller determines whether the plurality of jumper blocks have changed states based on the fingerprint value and a stored fingerprint value encoding previous states of the plurality of jumper blocks. At step 526, responsive to determining that the plurality of jumper blocks have changed states, the management controller obtains, via a communication interface, the current states of the plurality of jumper blocks.

In some embodiments, the programmable logic device comprises a complex programmable logic device, and the management controller comprises a baseboard management controller of a server or other computing platform. In some embodiments, each of the plurality of jumper blocks comprises a plurality of pins, and only one of the plurality of pins of each jumper block is electrically coupled to a respective one of the plurality of input pins of the programmable logic device such that a single sensed logic signal is sufficient to represent a state of each jumper block.

In some embodiments, generating the fingerprint value at step 514 comprises obtaining, in a same clock cycle of the programmable logic device, logic signals at the plurality of input pins and encoding the logic signals as a bit vector representing the current states of the plurality of jumper blocks, where the fingerprint value is generated based on the bit vector. In some embodiments, generating the fingerprint value further comprises applying a checksum function, a hash function, or a cyclic redundancy check function to the bit vector representing the current states of the plurality of jumper blocks.

In some embodiments, the communication interface used at steps 522 and 526 comprises at least one of an I²C interface or an SGPIO interface between the programmable logic device and the management controller. In some embodiments, the communication interface is configured to transfer, in a single transfer unit or clock interval, a first amount of data between the programmable logic device and the management controller, and the fingerprint value comprises a data size that is not greater than the first amount of data such that the fingerprint value is transferable over the communication interface in the single transfer unit or clock interval, while the current states of the plurality of jumper blocks are encoded in a second amount of data that exceeds the first amount of data such that obtaining the current states requires a plurality of transfer units or clock intervals over the communication interface.

In some embodiments, after the management controller obtains the current states of the plurality of jumper blocks at step 526, the management controller updates the stored fingerprint value to the newly obtained fingerprint value so that subsequent comparisons at step 524 are made against the latest confirmed configuration. In some embodiments, after determining that the plurality of jumper blocks have changed states and obtaining the current states of the plurality of jumper blocks via the communication interface, the management controller computes a recomputed fingerprint value based on the current states of the plurality of jumper blocks and determines that a transmission error has occurred when the recomputed fingerprint value differs from the fingerprint value obtained from the programmable logic device at step 522.

In some embodiments, the method further comprises determining, at the management controller, whether the plurality of jumper blocks are in a valid configuration based on the current states of the plurality of jumper blocks and a golden configuration table that defines one or more valid jumper configurations for the plurality of jumper blocks. The golden configuration table may comprise a plurality of mode specific profiles comprising at least a normal mode profile and a factory mode profile, and in some embodiments also a debug mode profile and other SKU or lifecycle specific profiles. In some embodiments, responsive to determining that the plurality of jumper blocks are not in the valid configuration, the management controller records an event in a system event log maintained by the management controller and causes a graphical user interface associated with the management controller to display an indication of the invalid jumper configuration. In some embodiments, responsive to determining that the plurality of jumper blocks are in an unsafe configuration comprising a mutually exclusive or hazardous combination of jumper states, the management controller inhibits a boot sequence of the circuit board, for example by preventing release of reset signals or by withholding enable signals for one or more power rails.

In some embodiments, the programmable logic device is configured to generate the fingerprint value and to assert an interrupt signal toward the management controller when the fingerprint value is ready, and the obtaining, from the programmable logic device, of the fingerprint value at step 522 is performed by the management controller in response to receipt of the interrupt signal. In other embodiments, the programmable logic device is configured to generate the fingerprint value periodically, and the obtaining of the fingerprint value at step 522 is performed by the management controller periodically polling the programmable logic device via the communication interface.

In some embodiments, the method further comprises generating the fingerprint value at the programmable logic device within a startup interval following application of power to the circuit board and before execution of main system firmware on the circuit board, and during a secure boot sequence initiated by at least one of the management controller and a basic input output system, comparing the fingerprint value with a reference fingerprint value stored as a factory record. In these embodiments, responsive to a mismatch between the fingerprint value generated within the startup interval and the reference fingerprint value, the method includes preventing completion of a boot of the computing system or causing the computing system to enter a mode that restricts operation of the computing system. In some embodiments, the circuit board is one of a plurality of circuit boards of a computing system, and each of the plurality of circuit boards comprises a respective programmable logic device that generates a respective fingerprint value encoding current states of jumper blocks on the respective circuit board. The method may further comprise obtaining the respective fingerprint values from the plurality of circuit boards and generating, at the management controller, a machine identifier based on the respective fingerprint values to characterize an overall hardware configuration of the computing system.

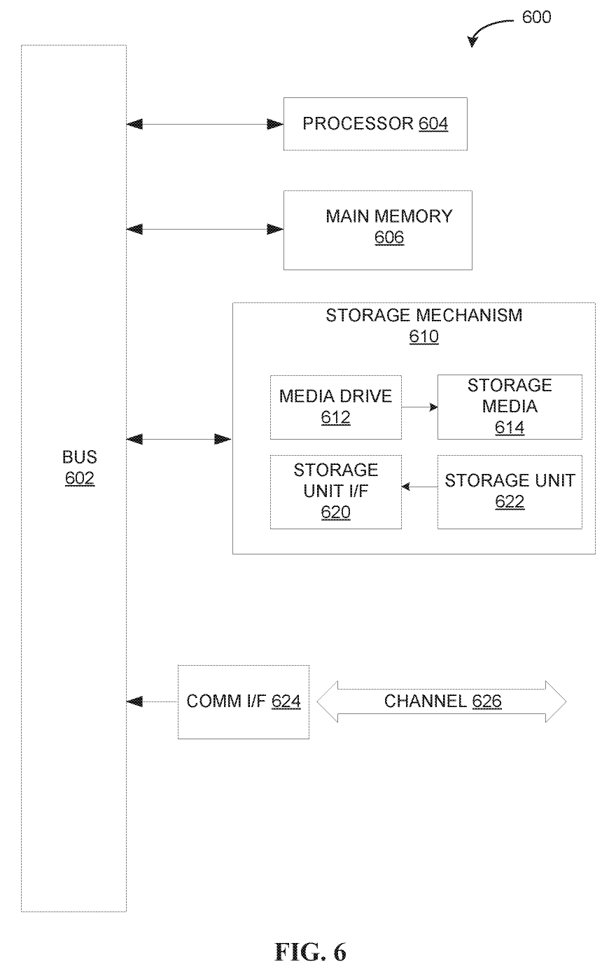

FIG. 6 illustrates an example computing system 600 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, tablet, cloud and edge, computers; hand-held computing devices (tablets, PDA’s, smart phones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally. The bus 602 may also be connected to other components such as a display, input devices, or cursor control to help facilitate interaction and communications between the processor and/or other components of the computing module 600.

Computing module 600 might also include one or more memory modules, simply referred to herein as main memory 606. For example, preferably random-access memory (RAM) or other dynamic memory might be used for storing information and instructions to be executed by processor 604. Main memory 606 might also be used for storing temporary variables or other intermediate information during execution of instructions to be executed by processor 604. Computing module 600 might likewise include a read only memory (“ROM”) or other static storage device 610 coupled to bus 602 for storing static information and instructions for processor 604.

Computing module 600 might also include one or more various forms of information storage devices 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD, DVD or Bluray drive (R or RW), or other removable or fixed media drive 612 might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit 622 and a storage unit interface 620. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 600.

Computing module 600 might also include a communications interface 624 or network interface(s). Communications or network interface(s) interface 624 might be used to allow software and data to be transferred between computing module 600 and external devices. Examples of communications interface or network interface(s) might include a modem or soft modem, a network interface (such as an Ethernet, network interface card, WiMedia, WiFi, IEEE 602.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 626. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 606, ROM, and storage unit interface 620. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method, comprising:
at a programmable logic device disposed on a circuit board:
receiving, via a plurality of pins of the programmable logic device, respective logic signals corresponding to a plurality of jumper blocks disposed on the circuit board; and
generating, based on the received logic signals, a fingerprint value encoding current states of the plurality of jumper blocks;
at a management controller communicatively coupled to the programmable logic device:
obtaining, from the programmable logic device, the fingerprint value;
determining whether the plurality of jumper blocks have changed states based on the fingerprint value and a stored fingerprint value encoding previous states of the plurality of jumper blocks; and
responsive to determining that the plurality of jumper blocks have changed states, obtaining, via a communication interface, the current states of the plurality of jumper blocks.

2. The method of claim 1, wherein the programmable logic device comprises a complex programmable logic device (CPLD) and the management controller comprises a baseboard management controller (BMC).

3. The method of claim 1, wherein each of the plurality of jumper blocks comprises a plurality of pins, and only one of the plurality of pins of each jumper block is electrically coupled to a respective one of the plurality of pins of the programmable logic device.

4. The method of claim 1, wherein generating the fingerprint value comprises:
obtaining, in a same clock cycle of the programmable logic device, logic signals present at the plurality of pins; and
encoding the logic signals as a bit vector representing the current states of the plurality of jumper blocks, wherein the fingerprint value is generated based on the bit vector.

5. The method of claim 1, wherein generating the fingerprint value comprises:
applying a checksum, hash function, or a cyclic redundancy check function, to a bit vector representing the current states of the plurality of jumper blocks.

6. The method of claim 1, wherein the communication interface comprises at least one of an I²C interface or an SGPIO interface.

7. The method of claim 1, wherein:
the communication interface is configured to transfer, in a single transfer unit or clock interval, a first amount of data between the programmable logic device and the management controller; and
the fingerprint value comprises a data size that is not greater than the first amount of data such that the fingerprint value is transferable over the communication interface in the single transfer unit or clock interval.

8. The method of claim 1, wherein the management controller is configured to:
update the stored fingerprint value to the obtained fingerprint value after obtaining the current states of the plurality of jumper blocks.

9. The method of claim 1, further comprising:
after determining that the plurality of jumper blocks have changed states and obtaining the current states of the plurality of jumper blocks via the communication interface, computing, at the management controller, a recomputed fingerprint value based on the current states of the plurality of jumper blocks; and
determining that a transmission error has occurred when the recomputed fingerprint value differs from the obtained fingerprint value.

10. The method of claim 1, further comprising:
responsive to determining that the plurality of jumper blocks have changed states, at the management controller, determining whether the plurality of jumper blocks are in a valid configuration based on the current states of the plurality of jumper blocks and a golden configuration table that defines one or more valid jumper configurations for the plurality of jumper blocks,
wherein the golden configuration table comprises a plurality of mode specific profiles comprising at least a normal mode profile and a factory mode profile.

11. The method of claim 10, further comprising:
responsive to determining that the plurality of jumper blocks are not in the valid configuration, recording an event in a system event log maintained by the management controller; and
causing a graphical user interface associated with the management controller to display an indication of an invalid jumper configuration.

12. The method of claim 1, further comprising:
responsive to determining that the plurality of jumper blocks are in an unsafe configuration comprising a mutually exclusive or hazardous combination of jumper states, inhibiting a boot sequence of the circuit board.

13. The method of claim 1, wherein:
the programmable logic device is configured to generate the fingerprint value and to assert an interrupt signal toward the management controller; and
the obtaining, from the programmable logic device, the fingerprint value is performed by the management controller in response to receipt of the interrupt signal.

14. The method of claim 1, wherein:
the programmable logic device is configured to generate the fingerprint value; and
the obtaining, from the programmable logic device, the fingerprint value is performed by the management controller periodically polling the programmable logic device via the communication interface.

15. The method of claim 1, further comprising:
at the programmable logic device, generating the fingerprint value within a startup interval following application of power to the circuit board and before execution of main system firmware on the circuit board; and
during a secure boot sequence initiated by at least one of the management controller and a basic input output system (BIOS), comparing the fingerprint value with a reference fingerprint value stored as a factory record; and
responsive to a mismatch between the fingerprint value generated within the startup interval and the reference fingerprint value, preventing completion of a boot of the computing system, or causing the computing system to enter a mode that restricts operation of the computing system.

16. The method of claim 1, wherein:
the circuit board is one of a plurality of circuit boards of a computing system;
each of the plurality of circuit boards comprises a respective programmable logic device that generates a respective fingerprint value encoding current states of jumper blocks on the respective circuit board; and
the method further comprises:
obtaining the respective fingerprint values from the plurality of circuit boards, and
generating, at the management controller, a machine identifier based on the respective fingerprint values.

17. A computing system, comprising:
a circuit board;
a plurality of jumper blocks disposed on the circuit board configured to set respective hardware parameters of a plurality of subsystems of the computing system;
a programmable logic device disposed on the circuit board and comprising a plurality of pins;
a plurality of electrical connections respectively coupling each of the plurality of jumper blocks to a corresponding one of the plurality of pins of the programmable logic device such that logic signals at the plurality of jumper blocks are sensed by the programmable logic device;
a management controller communicatively coupled to the programmable logic device via a communication interface;
wherein the programmable logic device is configured to generate a fingerprint value encoding the sensed logic signals at the plurality of jumper blocks, and provide the fingerprint value to the management controller via the communication interface;
wherein the management controller is configured to:
obtain the fingerprint value from the programmable logic device via the communication interface, and
determine whether the plurality of jumper blocks have changed states based on the fingerprint value and a stored fingerprint value encoding previous states of the plurality of jumper blocks.

18. The computing system of claim 17, wherein the plurality of subsystems comprise power regulation circuitry related to the programmable logic device and at least one of a central processing unit (CPU), a basic input output system (BIOS), a graphics processing unit (GPU), and a peripheral component interconnect express (PCIe) subsystem.

19. The computing system of claim 17, wherein the management controller is further configured to, responsive to determining that the plurality of jumper blocks have changed states, determine whether the plurality of jumper blocks are in a valid configuration based on the current states of the plurality of jumper blocks and a golden configuration table that defines one or more valid jumper configurations for the plurality of jumper blocks,
wherein the golden configuration table comprises a plurality of mode specific profiles comprising at least a normal mode profile and a factory mode profile.

20. A non-transitory computer-readable medium storing instructions that, when executed by a management controller of a computing system, cause the management controller to perform operations comprising:
obtaining, from a programmable logic device disposed on a circuit board of the computing system, a fingerprint value encoding current states of a plurality of jumper blocks disposed on the circuit board, wherein the programmable logic device has generated the fingerprint value based on logic signals received via a plurality of pins of the programmable logic device that are respectively coupled to the plurality of jumper blocks;
determining whether the plurality of jumper blocks have changed states based on the fingerprint value and a stored fingerprint value encoding previous states of the plurality of jumper blocks; and
responsive to determining that the plurality of jumper blocks have changed states, obtaining, via a communication interface, the current states of the plurality of jumper blocks.
